(19) United States
(12) Patent Application Publication
(10) Pub. No.: US 2019/0266580 A1
(43) Pub. Date: Aug. 29, 2019

(54) ELECTRONIC TRANSFER TRACKING USING VIRTUAL WALLETS

(71) Applicant: CA, Inc., Islandia, NY (US)

(72) Inventor: Robin Hopper, Prague (CZ)

(21) Appl. No.: 15/905,819

(22) Filed: Feb. 26, 2018

(51) Int. Cl. G06Q 20/10; G06Q 20/38; G06Q 20/36

(52) U.S. Cl. CPC G06Q 20/108; G06Q 2220/00; G06Q 20/36; G06Q 20/3829

(57) ABSTRACT

An electronic financial transfer request is received, which identifies that a first destination financial institution is a destination for a corresponding electronic financial transfer. An encrypted virtual wallet is generated, which is encrypted by a key private to a first computing system associated with a second financial institution. The encrypted virtual wallet is sent to a second computing system associated with the first financial institution. A transaction record is generated for the virtual wallet. The transaction record is generated to identify the first destination financial institution, the transaction record private to the first computing system. Data is received from a third computing system associated with a third financial institution to identify that the virtual wallet was transferred from the first financial institution to the third financial institution. The transaction record is updated to identify that the virtual wallet was transferred from the first financial institution to the third financial institution.

### BACKGROUND

The present disclosure relates in general to the field of computer systems, and more specifically, to digital security in computer network communications.

With the advent of the Internet and e-commerce, computing systems have been developed to enable many traditional banking and other financial transactions to be handled electronically. Slowing the adoption of such systems are lingering concerns that electronic transactions and accounts may be more susceptible to exploitation, or hacks, by unscrupulous actors. Despite the development of many security procedures and technologies governing data records, authentication, and communications in connection with electronic financial transactions, news stories continue to highlight the evolving variety of hacks, thefts, and other exploits endangering the assets of users and entities entrusting their transactions to modern banking and e-commerce systems.

### BRIEF SUMMARY

According to one aspect of the present disclosure, an electronic financial transfer request may be received, which identifies that a first destination financial institution is a destination for a corresponding electronic financial transfer. An encrypted virtual wallet may be generated, which is encrypted by a key private to a first computing system associated with a second financial institution. The encrypted virtual wallet can be sent to a second computing system associated with the first financial institution. A transaction record is generated for the virtual wallet. The transaction record may be generated to identify the first destination financial institution, the transaction record private to the first computing system. Data may be received from a third computing system associated with a third financial institution to identify that the virtual wallet was transferred from the first financial institution to the third financial institution. The transaction record may be updated to identify that the virtual wallet was transferred from the first financial institution to the third financial institution.

According to another aspect of the present disclosure, an encrypted virtual wallet may be received from another computing system over a communications network. The virtual wallet corresponds to an electronic financial transfer and is received at a first electronic fund transfer system, associated with a first financial institution, from a second electronic fund transfer system associated with a second financial institution. The first financial institution may be identified from the virtual wallet and receipt data may be generated, which corresponds to the virtual wallet. The receipt data may be sent to the first electronic fund transfer system to report receipt of the virtual wallet by the second financial institution.

### BRIEF DESCRIPTION OF THE DRAWINGS

FIG. 1 illustrates a simplified schematic diagram of an example computing environment including example electronic financial transaction systems.

FIG. 2 illustrates a simplified block diagram of an example software system including systems capable of generating and handling encrypted virtual wallet structures.

FIGS. 3A-3D are simplified block diagrams representing example transfers of a virtual wallet structure between computing systems.

FIGS. 4A-4D are simplified block diagrams representing example transfers of child virtual wallet structure between computing systems.

FIGS. 5A-5B are flowcharts illustrating example techniques for using virtual wallet structures in association with the electronic transfer of financial assets.

Like reference numbers and designations in the various drawings indicate like elements.

### DETAILED DESCRIPTION

As will be appreciated by one skilled in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or as a combination of software and hardware implementations, all of which may generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices, to produce a computer implemented process such that the instructions which execute on the computer or other programmable apparatus provide processes for implementing the functions/acts specified in the flowchart and/or block diagram block or blocks.

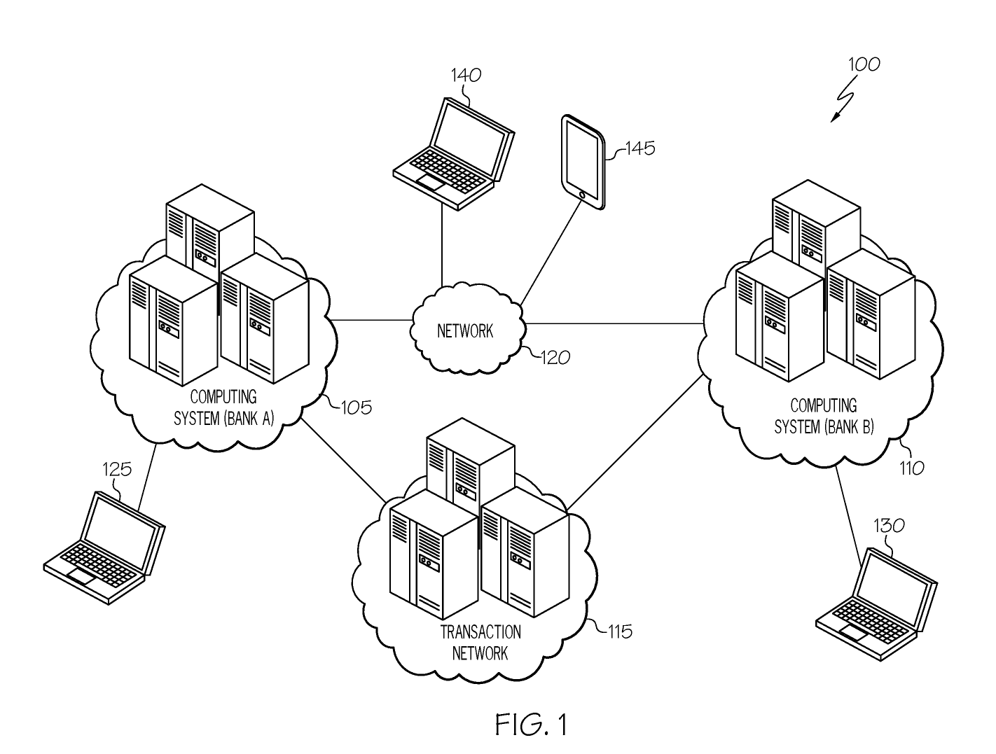

FIG. 1 illustrates a simplified schematic diagram of an example computing environment 100. In some embodiments, computing environment 100 may include functionality to enable the communication of network data to effect electronic financial transactions to take place between financial institutions. Such financial transactions may include transfers of funds from one account at one bank to another account at another bank. For instance, various computing systems (e.g., 105, 110) may be provided, which are each associated with a respective financial institution. For instance, a first private computing system 105 may be associated with Bank A, while a second private computing system 110 may be associated with Bank B. In the interest of protecting the accounts and funds of each respective financial institution, each computing system 105, 110 may be secured through a variety of hardware- and software-based security tools. The security tools may prevent unauthorized access to and communication with the respective computing system of a financial institution.

Indeed, to facilitate transactions between banking computing systems (e.g., 105, 110), a specialized transaction network 115 may be defined (and facilitated over one or more private and/or public communication networks) to enable inter-system communication between banks to complete inter-bank transactions. For instance, a transaction network 115 may be implemented as a financial messaging network such as the Society for Worldwide Interbank Financial Telecommunication (SWIFT) network, the Financial Services Network (FSN), A Ripple Transaction Protocol (RTP) network, among other example implementations. In some implementations, access to the transaction network 115 may be tightly controlled, with access limited to accounts restricted to authorized banking professionals, specialized communication terminals or clients (e.g., 125, 130), among other example controls. While the transaction network 115 may assist in providing a level of trust and security to financial transactions conducted between banks (using their respective computing systems 105, 110), such trust and security may assume the trustworthiness and physical security of a bank. For instance, if a banking professional is compromised, who otherwise is permitted access to a corresponding banking computing system, the compromised banking professional may be leveraged to initiate fraudulent or wrongful bank transactions using the transaction network 115. Accordingly, in some implementations, additional technologies may be employed on top of the levels of security provided for implementing the transaction network 115 to guard against financial crimes, which may be carried out using the transaction network 115.

Modern banking customers have come to demand not only the ability to complete inter-bank transactions, but to have some visibility into their accounts, and thus the banking systems of their financial institutions. Accordingly, in some implementations, banking computing systems (e.g., 105, 110) may additionally provide connectivity to their users through public networks, (e.g., 120), such as the Internet. For instance, banking customers may utilize personal computing devices (e.g., 140, 145) to connect to a banking computing system 105, 110 through a public network 120. Users may thereby gain limited access to data and services directed related to their account by logging in and authenticating their device(s) (e.g., 140, 145) to perform online banking tasks, such as initiating wire transfers, performing intrabank and interbank money transfers, schedule bill payments, among other examples. In some instances, a transaction initiated by a user computing device (e.g., 140, 145) logged into a banking computing system (e.g., 105, 110) may cause messaging through transaction network 115 between banking computing systems (e.g., 105, 110), among other example scenarios and use cases.

In general, elements of computing environment 100, such as “systems,” “servers,” “services,” “hosts,” “devices,” “clients,” “networks,” “mainframes,” “computers,” and any components thereof (e.g., 105, 110, 115, 125, 130, 140, 145, etc.), may be used interchangeably herein and refer to electronic computing devices operable to receive, transmit, process, store, or manage data and information associated with computing environment 100. As used in this disclosure, the term “computer,” “processor,” “processor device,” or “processing device” is intended to encompass any suitable processing device. For example, elements shown as single devices within computing environment 100 may be implemented using a plurality of computing devices and processors, such as server pools comprising multiple server computers. Further, any, all, or some of the computing devices may be adapted to execute any operating system, including Linux, other UNIX variants, Microsoft Windows, Windows Server, Mac OS, Apple iOS, Google Android, etc., as well as virtual machines adapted to virtualize execution of a particular operating system, including customized and/or proprietary operating systems.

Further, elements of computing environment 100 (e.g., 105, 110, 115, 125, 130, 140, 145, etc.) may each include one or more processors, computer-readable memory, and one or more interfaces, among other features and hardware. Servers may include any suitable software component or module, or computing device(s) capable of hosting and/or serving software applications and services, including distributed, enterprise, or cloud-based software applications, data, and services. For instance, one or more of the described components of computing environment 100, may be at least partially (or wholly) cloud-implemented, “fog”-implemented, web-based, or distributed for remotely hosting, serving, or otherwise managing data, software services, and applications that interface, coordinate with, depend on, or are used by other components of computing environment 100. In some instances, elements of computing environment 100 may be implemented as some combination of components hosted on a common computing system, server, server pool, or cloud computing environment, and that share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Despite the security infrastructure in place within some banking transaction networks, such as the SWIFT messaging network, thieves, hackers, and other malicious actors continue to penetrate the banking system to facilitate damaging financial crimes. For instance, by compromising a bank employee or hacking into a banking computing system, a malicious actor may wrongfully transfer large sums of money from a victim bank to one or more target banks in order to steal the money that has been wrongfully transferred from the victim bank. To facilitate the success of such a heist, it is typical for the malicious actors to transfer these funds multiple time across multiple financial institutions—this adds complexity and time to assist the malicious actor in actually withdrawing the stolen cash and make the theft difficult to trace. In some cases, the ultimate goal of the malicious actor is to transfer the stolen funds to the bank of a country where money laundering and other financial criminal laws are lax or poorly enforced. When successful, financial crimes of this kind may it almost impossible to recover all of the stolen funds. These weaknesses in the global financial system, when unaddressed, will only encourage an increasing number of crimes of this kind. In some implementations, a cryptographic transaction, or wallet, may be defined and implemented using cryptographic logic implemented on banking computing systems to add an additional layer of security to interbank financial transactions, such as set forth in the examples below. Systems implementing such cryptographic wallets may address at least some of the example issues and shortcomings of existing systems above, among other example advantages.

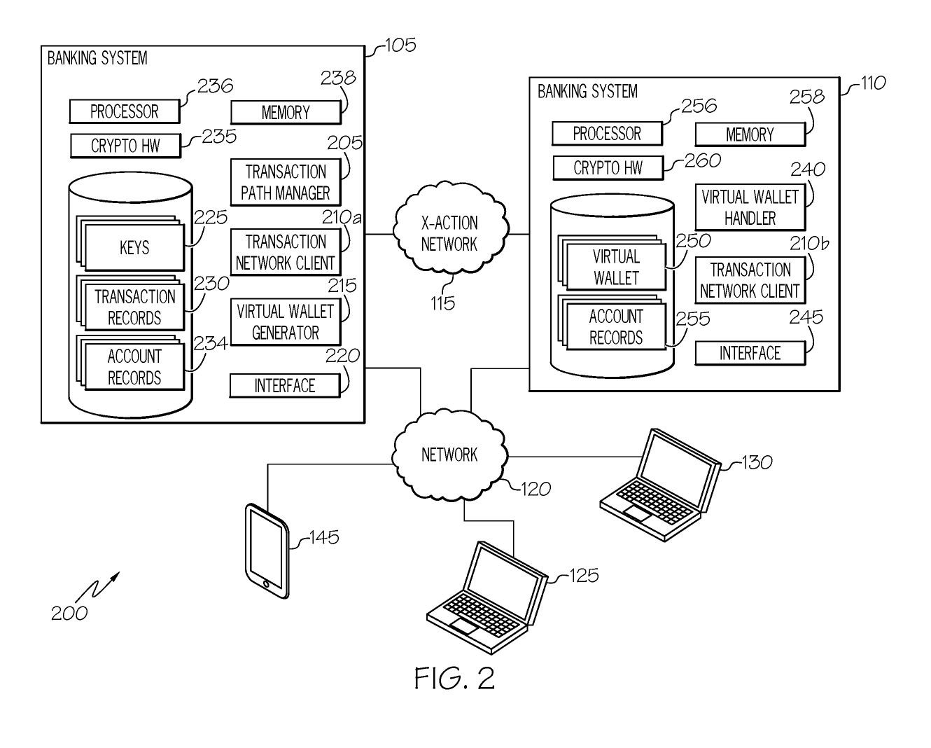

Turning to FIG. 2, a block diagram 200 is shown of an example system including example banking computing systems 105, 110 equipped with hardware and/or software configured to implement a cryptographic virtual wallet to be used in interbank transfers. Such virtual wallets may facilitate end-to-end tracking and visibility of transactions, making it difficult for malicious actors to move money from one bank or country to the next without scrutiny. In one implementation, example banking systems (e.g., 105, 110) may include one or more data processing apparatus (e.g., 236, 256), one or more computer memory elements (e.g., 238, 258), as well as cryptographic hardware (e.g., 235, 260) utilized to perform cryptographic processing in connection with the generation and handling of example virtual wallets (e.g., 250) used in example interbank financial transactions. Hardware, firmware, and/or software of a banking system 105 may be utilized to implement various components to be used in initiating, processing, and protecting financial transactions of a corresponding financial institution.

In one example, at least some banking system implementations may include a transaction path manager 205 to be used in association with virtual wallets generated in connection with financial transactions by a virtual wallet generator 215 implemented on the banking system (e.g., 105). A virtual wallet may be generated utilizing private cryptographic keys 225 obtained by or generated at the banking system (e.g., 105). A virtual wallet may be sent, in some cases, over a transaction network to represent cleared funds being transferred in a corresponding transaction. Banking systems (e.g., 105, 110) may include a transaction network client (e.g., 210a-b) to enable the banking system to connect to a corresponding transaction network (e.g., 115) and send messages over the network 115 to other banking systems. Virtual wallets generated by a banking computing system (e.g., 105) may be encapsulated in a message sent over the transaction network 115 in some implementations.

Receipt of a virtual wallet by a receiving banking system (e.g., 110) may trigger additional messaging, which may likewise be completed over a transaction network 115 (or another network (e.g., 120)). For instance, at least a portion of virtual wallet may be encrypted using a private key (e.g., 225) of the original source bank. Liquidation of funds within the wallet may be conditioned on the content of the virtual wallet being decrypted. Accordingly, a liquidating banking system (e.g., 110) may communicate with the source banking system (e.g., 105) over a network and request a copy of the private key or key pair for use in decrypting the virtual wallet. Receipt of the virtual wallet may also involve the sending of an acknowledgment message to the source banking system 105 to enable tracking of the virtual wallet and subsequent transfers of funds represented by the virtual wallet (which may be tracked using transaction path manager 205), among other example features. When a virtual wallet is decrypted, a proof of the decryption may be provided to the source banking system to confirm that the funds “within” the virtual wallet have been liquidated, resulting in the disposal of the virtual wallet and updating of transaction records (e.g., 230) to indicate that funds that were previously in the account of the source bank (e.g., as recorded in account records 234) have been successfully transferred and liquidated at a destination bank (e.g., 110) (which may or more may not be the initial destination of the funds transfer).

When virtual wallets are transmitted from one banking system (e.g., 105) to another (e.g., 110) in a transaction, the funds represented by the virtual wallet may be reflected as subtracted from the source account (e.g., in account records 234) and added to the account of the receiving bank (e.g., as expressed in account records 255). Accordingly, the receiving account may then forward the funds to a subsequent bank account, and so on. However, rules may be established such that the funds represented by the virtual wallet may not be liquidated without decryption of the virtual wallet. Further, rules may cause any bank receiving the virtual wallet to report the receipt of the virtual wallet to a source bank (e.g., corresponding to system 105) identified in the wallet. Should the overall funds of the wallet be divided (e.g., to keep some funds in one account and forward remaining wallet funds to another account, or to forward the funds of the account to multiple subsequent accounts, etc.) the bank desiring the division may request substitute wallets from the original source bank, as the wallet, as generated, corresponds to an undivided amount of funds, among other example implementations. A virtual wallet handler (e.g., 240) on a receiving banking system (e.g., 110) may include functionality for reporting the receipt of a virtual wallet to a source banking system (e.g., 105), requesting wallet splitting in response to detecting a request (e.g., through a user system 125, 130, 140) to divide funds of a received wallet, request a key corresponding to a virtual wallet (i.e., in response to detecting a requested liquidation event at the banking system 110), and decrypting the virtual wallet using a received key to enable liquidation of the virtual wallet's funds, among other example functionality.

While the example of FIG. 2 shows a virtual wallet generator 215 hosted at a first banking system and a virtual wallet handler (e.g., 240) hosted at a second banking system, it should be appreciated that banking systems may be the source of a transaction in some instances and the destination of transactions in other instances. Accordingly, example banking systems (e.g., 105, 110) may be equipped with both virtual wallet generators (e.g., 215) and virtual wallet handlers (e.g., 240) to facilitate the banking systems' participation in a wide variety of transactions. Further, different types of virtual wallets and encryption schemes may be utilized in various transactions. For instance, one virtual wallet may be according to a first scheme, while other virtual wallets are according to a second scheme. While some implementations may provide standardization of the virtual wallets and virtual wallet generation and handling, other examples may provide for multiple competing schemes and individual banking systems (e.g., 105, 110) may be equipped with logic (e.g., 235, 260, 205, 240, etc.) which enables the banking systems to participate in and support multiple different virtual wallet schemes, among other examples.

As noted above, user computing systems (e.g., 125, 130, 145, etc.) associated with banking professionals or account holders (or even malicious actors) may interface with banking systems (e.g., 105, 110) to cause transactions and communications between banking systems (e.g., over networks 115, 120). Interfaces (e.g., 220, 245) may be provided through the respective banking system (e.g., 105, 110), and based on the user (e.g., employee or customer), to enable the initiation and processing of various banking transactions. For instance, various graphical user interfaces (GUIs) may be provided through which a new funds transfer may be initiated. A GUI may be provided, for instance, to allow a customer (e.g., using computer 145) to request a wire or other fund transfer. Another GUI may be provided for access and use by a bank employee to request the generation and use of a virtual wallet to implement a requested fund transfer. In some cases, virtual wallets may be generated automatically for any bank-to-bank fund transfer, among other example implementations. Handling receiving virtual wallet-based fund transfers may also involve the use of a user interface. For instance, in some cases requesting a liquidation or wallet split may necessitate the involvement of a banking professional, to provide a level of oversight prior to the funds in a transaction being liquidated (e.g., as the liquidation of the funds makes recovery of those funds much more difficult). In some cases, the additional protections afforded by a virtual wallet or human-led liquidation request, etc. may be predicated on certain rules or machine-guided analyses of transactions (e.g., artificial intelligence or machine learning-assisted transaction analysis to detect suspicious transaction requests or activity), which may trigger the implementation of such safeguards, among other example implementations.

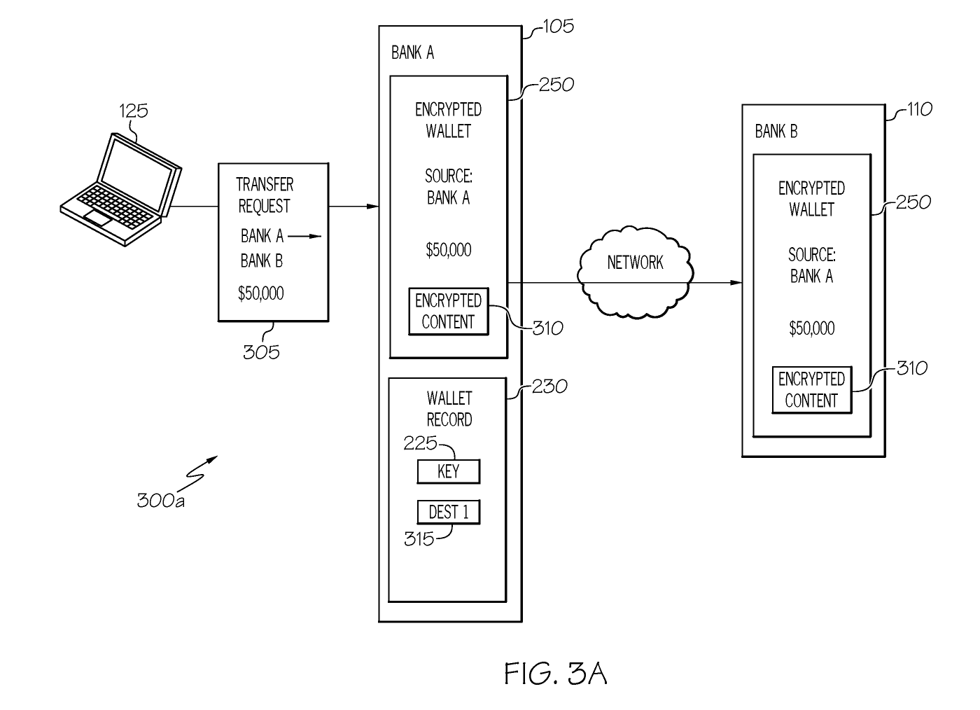

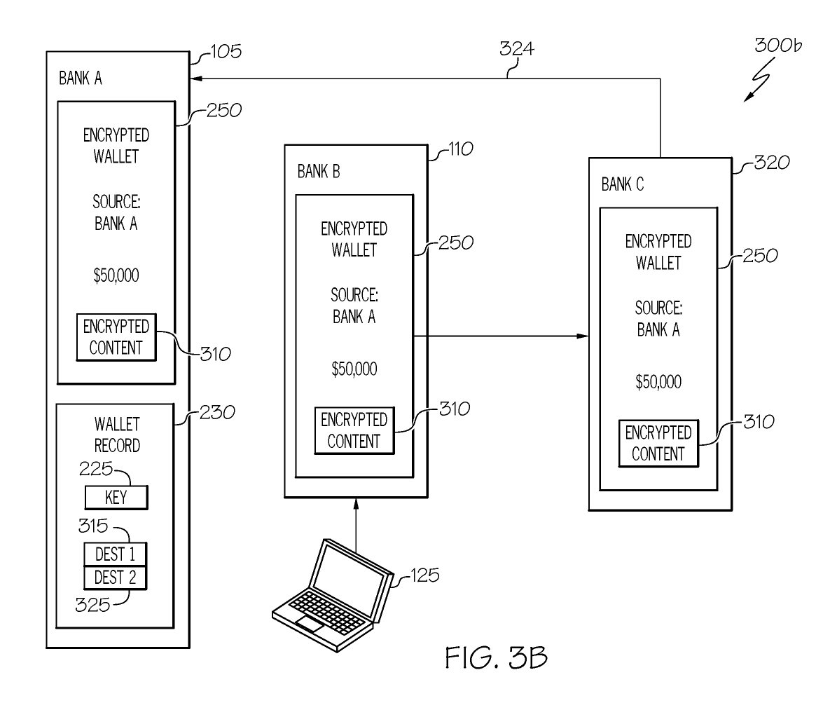

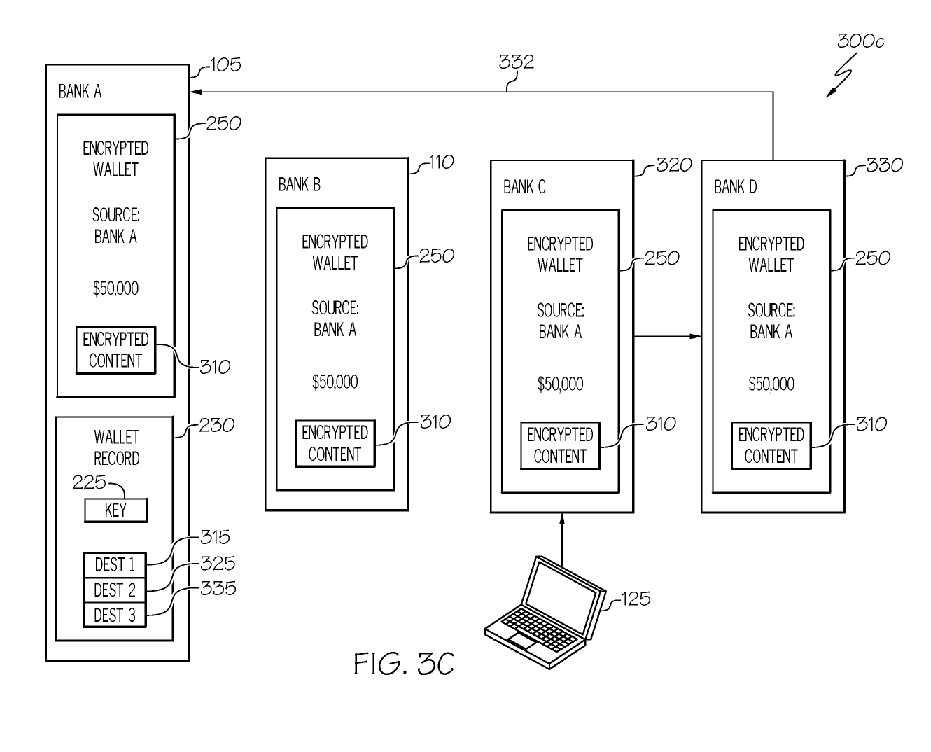

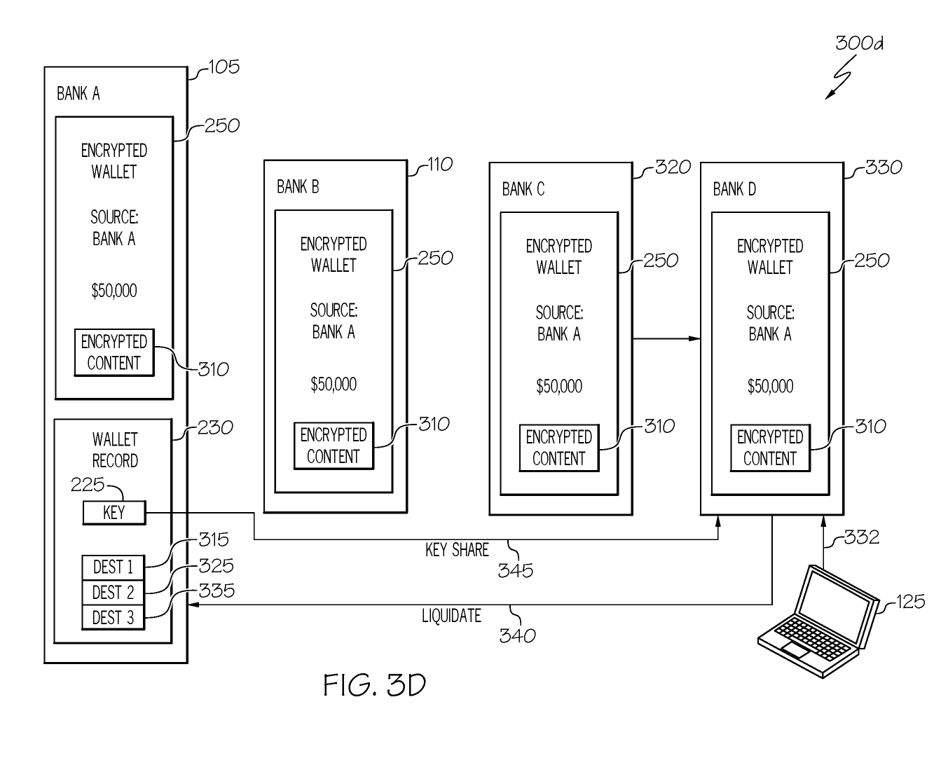

FIGS. 3A-3D are simplified block diagrams 300a-d illustrating the example use of an encrypted virtual wallet to facilitate an interbank transaction. In the example of FIG. 3A, a user may utilize a user computing device 125 to initiate a communication with banking system 105 (of Bank A) to request a transfer of funds from Bank A to Bank B. In this particular example, the amount of funds is $50,000, as detailed in a transfer request 305 generated using computing device 125. The system 105 of Bank A may identify the request 305 and generate an encrypted virtual wallet structure 250 to correspond to the request. The virtual wallet 250 may serve to represent the $50,000 in funds. The virtual wallet may include encrypted content 310, which is encrypted using a private key 225 held by Bank A. The key 225 may be a single use key, such that the key 225 is used (and, in some cases, generated) specifically to encrypt the content 310 of this particular virtual wallet 250. Other virtual wallets used in other transactions may utilize other, unique keys. In addition to the generation of the virtual wallet 250, the banking system 105 may generate, with the virtual wallet 250, a wallet transaction record 230 (or simply a “wallet record”). A wallet record (e.g., 230) may be generated for each virtual wallet generated by a banking system 105 for a transfer initiated by the banking system 105. In one example, the wallet record may include an identification of the key 225 used to encrypt the corresponding virtual wallet 250 (or may include the key 225 itself) and may include a destination record including information identifying the bank (e.g., Bank B) that is to receive the virtual wallet 250 from Bank A (in accordance with the transfer request 305).

With the virtual wallet 250 and corresponding wallet record 230 generated, the banking system 105 of Bank A may transmit the encrypted virtual wallet to a banking computing system 110 associated with destination Bank B over a network. As noted above, in some cases, the virtual wallet 250 may be communicated as a message over a specialized bank transaction network. The recipient banking system 110 may receive the virtual wallet 250 and may identify a protocol associated with the virtual wallet. In this example, the banking system 110 may identify, from the virtual wallet 250, that Bank A is the original creator of the virtual wallet 250 and may further determine that the virtual wallet 250 was directly received from the system 105 associated with Bank A. Accordingly, the system 110 of Bank B may determine that no acknowledgement is needed to be sent from the system 110 of Bank B to the system 105 of Bank A (e.g., as Bank A is aware that the virtual wallet 250 was sent to the system 110 of Bank B. Further, upon receipt of the virtual wallet 250, the system 110 of Bank B may process the virtual wallet to identify the corresponding transfer of $50,000 and may update balances of one or more accounts (e.g., in accordance with a correspondent banking relationship) and perform a settlement in association with the transaction. The funds from the virtual wallet 250, however, may not be liquidated without decryption of the encrypted content 310 within the virtual wallet 250. Accordingly, the system 110 of Bank B may simply hold the virtual wallet 250 until a liquidation request is received from a user associated with the account receiving the funds of the virtual wallet 250.

Turning to FIG. 3B, a user (at device 125) may request that the newly deposited funds in the virtual wallet 250 be further transferred to a third bank, Bank C. Accordingly, the banking system 110 of Bank B may transmit the encrypted wallet to a banking system 320 associated with Bank C. When the system 320 of Bank C receives the virtual wallet 250, it may read the virtual wallet 250 to identify that the virtual wallet originated at the system 105 of Bank A. The system 320 of Bank C may additionally identify (e.g., from information in the transaction network message used to send the virtual wallet) that the virtual wallet was sent to the system 320 of Bank C by a system 110 associated with Bank B (i.e., and not the system 105 listed in the virtual wallet 250 as responsible for creating and originally sending the virtual wallet). Accordingly, the banking system 320 may identify that system 105 is the originator of the virtual wallet and send a message 324 to the originating system 105 to report to the originating system that the virtual wallet 250 has been sent to the banking system 320 associated with Bank C. The message 324 may include information identifying the banking system 320 and an identifier of the virtual wallet (e.g., a globally unique identifier (GUUID)). In response to receiving this message 324, the originating system 105 may identify that the virtual wallet 250 now resides with the system 320 of Bank C and may create a corresponding destination record 325 to identify Bank C within the wallet record 230. Accordingly, the updated wallet record 230 may identify the path of the transaction, with the virtual wallet first being sent to Bank B followed by Bank C. Based on this information, the system 105 of Bank A may expect that a valid liquidation request would come from Bank C and not Bank B, as Bank C has reported the transfer of the virtual wallet 250 from Bank B to Bank C by virtue of message 324. Indeed, in some implementations, system 105 may possess logic to check the validity of liquidation requests relating to outstanding virtual wallets based on the most recent destination reported for the virtual wallet in its corresponding wallet record.

Continuing with the preceding example, prior to being liquidated, the virtual wallet 250 may be further transferred several more times to various other financial institutions. Indeed, in cases of a malicious actor and transfer, it may even be likely that such multiple transfers occur. Turning to FIG. 3C, the system 320 of Bank C may receive a user request (e.g., from system 125) to further transfer funds associated with a virtual wallet to another financial institution (e.g., Bank D). Accordingly, as in the example of FIG. 3B, the latest recipient of the virtual wallet (e.g., the system 320 of Bank C) may further transfer the virtual wallet 250 to the requested system (e.g., the system 330 of Bank D). The receiving system (e.g., 330) may determine whether or not the virtual wallet was received from the system identified as creating the virtual wallet. In some implementations, if the recipient system receives the virtual wallet directly from the originating system (e.g., 105), the recipient system does not send a notification message to report receipt of the virtual wallet to the originating system. If, however, the recipient system (e.g., 330) determines that the virtual wallet 250 was received from a system (e.g., 320) other than the originating system (e.g., 105), the recipient system (e.g., 330) may determine that a reporting message 332 is to be sent, such as in the example of FIG. 3C. Likewise, when the originating system 105 receives a subsequent reporting message (e.g., 332) corresponding to a particular virtual wallet (e.g., 250), the originating system 105 may update a corresponding wallet record 230 to add another destination record 235 to identify the sender of the latest reporting message 332 and identify the current “holder” of the virtual wallet 250, and so on.

The process illustrated in FIGS. 3B and 3C may continue as a virtual wallet 250 is transferred from banking system to banking system, until a liquidation request is received and the virtual wallet is “emptied” of its funds. For instance, as shown in the example of FIG. 3D, after receiving the virtual wallet 250 and reporting the receipt of the wallet to the originating banking system 105, the banking system 330 of Bank D may receive a liquidation request 342 from a user through a device (e.g., 125). In response, the banking system 330 may automatically (or in response to direction by a banking employee (e.g., upon review of the request 342)) identify, from the virtual wallet 250, that the originating system of the virtual wallet 250 is the banking system 105 of Bank A and transmit a liquidation request 340 from the system 330 of Bank D to the system 105 of Bank A. The liquidation request 340 may include an identification of the corresponding virtual wallet 250. The receiving system 105 may further identify, from a corresponding wallet record 230, that the liquidation request 340 is received from a banking system (e.g., 330), which the originating system 105 expects to be the current holder of the virtual wallet. Based on this observation, the originating system 105 may validate the liquidation request 340 (e.g., based on it being sent from the current holder of the virtual wallet 250) and send a key 345 (over a secured communication channel, such as a channel of a transaction network) to the system 330 of the bank attempting to liquidate the wallet funds. In this example, the system 330 of Bank D may receive the key share message 345 and use the included key to decrypt the encrypted content 310 within the virtual wallet. Successful decryption of the content 310 may formalize the liquidation of the wallet 250 and the banking system 330 may authorize the $50,000 to be liquidated and paid out to a user associated with the liquidation request 332. In some implementations, the liquidating system 330 may send a proof of the decryption of the virtual wallet to the originating bank's system 105, which the originating bank may use to retire the wallet 250 (and corresponding wallet record 230). In some cases, liquidation may depend on a proof being sent from the liquidating bank system 330 to the originating bank system 105 (e.g., with the proof including the decrypted content as reported by the liquidating bank system) and a confirmation sent from the originating bank's system 105 in response to the proof to confirm that the proof is correct (and that the originating bank acknowledges the rightful liquidation of the wallet 250), among other example protocols.

As shown in the example of FIGS. 3A-3D, an encrypted virtual wallet 250 may be utilized to further secure an inter-bank transfer. Similar wallets may be utilized to transfer other types of financial assets (e.g., other than raw currency), such as securities, and other examples. As noted above, assets may be packaged into a virtual wallet, the use of which may facilitate the creation of a ledger (e.g., the wallet record) at the issuing financial institution. This can allow the financial asset within the virtual wallet to be securely transferred and the flow of the transfer to be tracked. With liquidation of the asset conditioned on the provision of a key by the originating system, the contents of the virtual wallet may only become convertible into a usable (and potentially irretrievable) form (e.g., for exploitation by a malicious actor) when the originating institution effectively approves the liquidation through provision of the key. In this manner, money (or other assets) may be transferred and guaranteed as a virtual currency, with the issuance of the key giving the bank extra time to identify what may have originally been a fraudulent transfer. Further, if it is determined that the transaction utilizing the virtual wallet is fraudulent, or otherwise wrongful, the originating institution may simply refuse to provide the corresponding unlock key and may cause the entire transfer(s) to be undone (e.g., without the actual funds being liquidated, complicating their retrieval), among other example use cases and advantages.

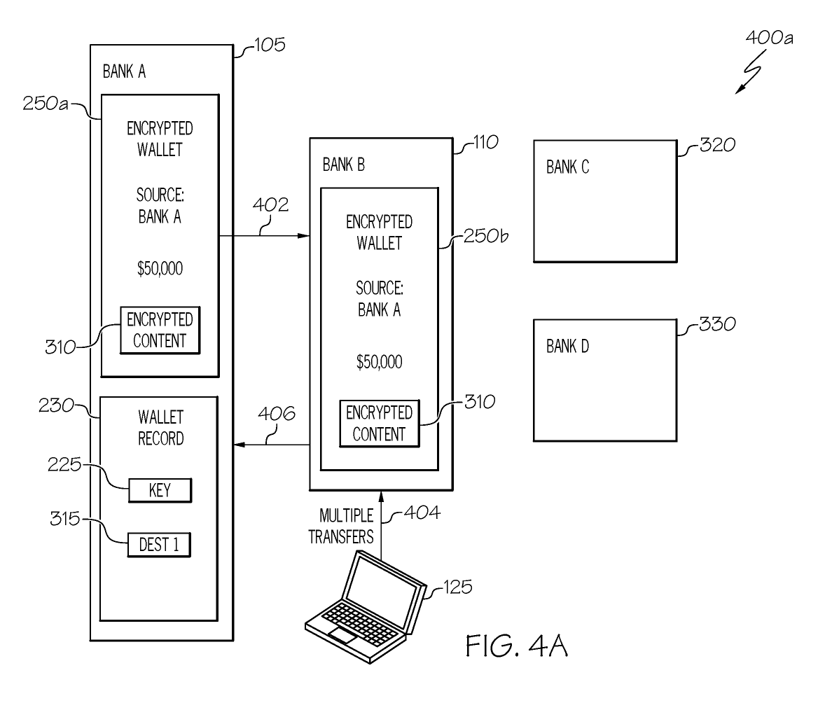

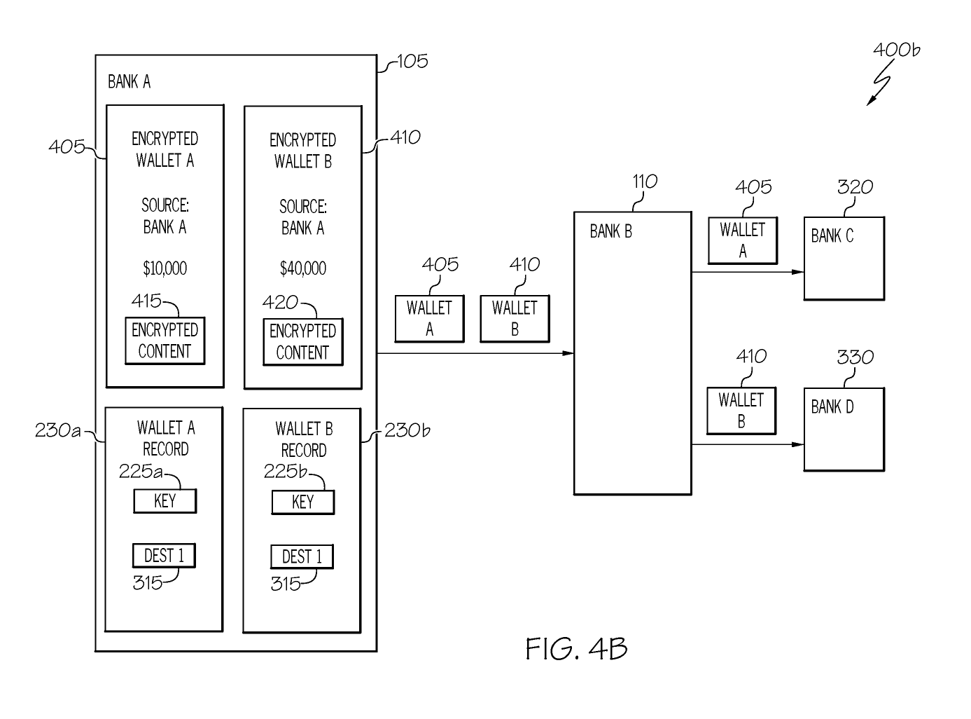

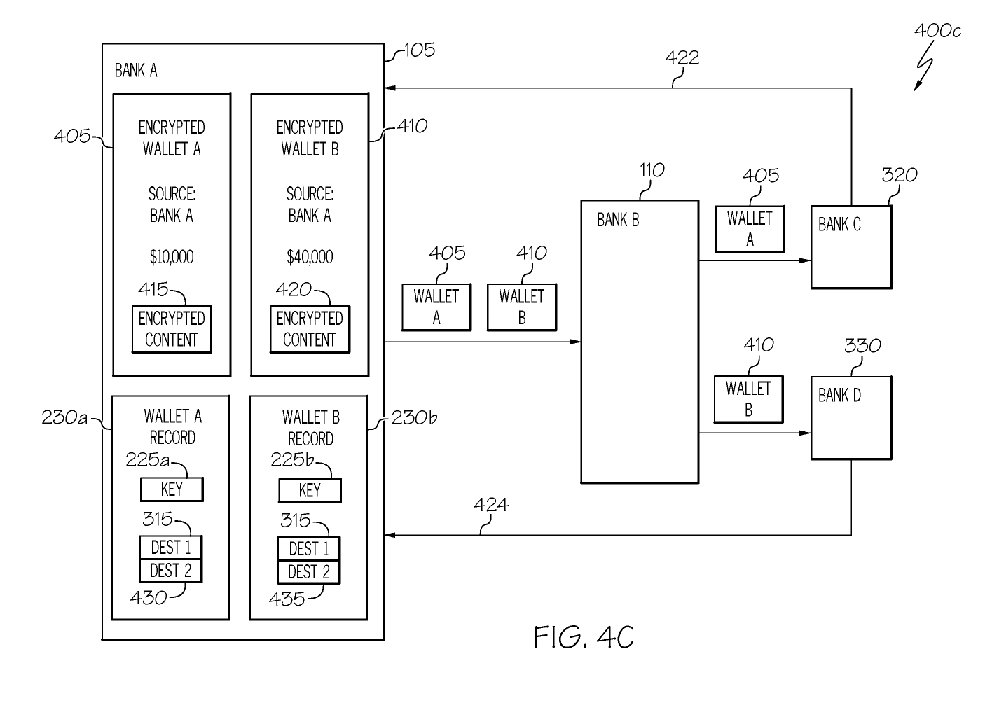

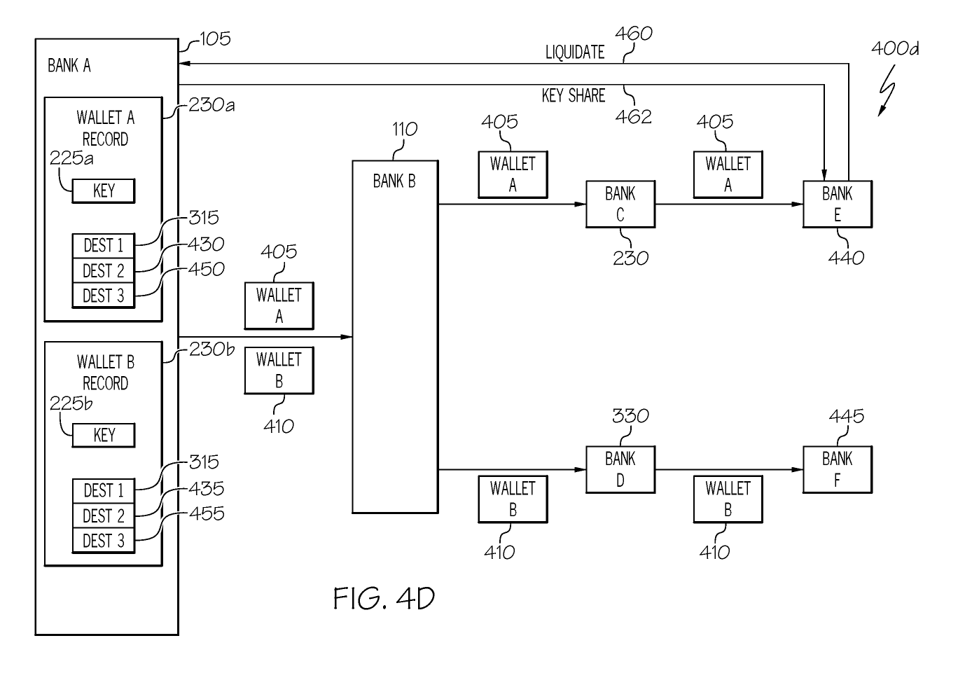

In the example of FIGS. 3A-3D, an example virtual wallet is shown to be transferred (and tracked) across multiple banking systems as a unitary whole. That is, the entire value and contents of the virtual wallet are transferred with the wallet at each hop between systems. While such transactions may take place, more complex transactions may also be supported utilizing virtual wallets and the systems equipped with logic for generating and handling such virtual wallet structures. For instance, turning to the examples illustrated in the simplified block diagrams 400a-d of FIGS. 4A-4D, in some cases a user may request that the funds within a virtual wallet be divided, for instance, to transfer a portion of the funds to a first account and one or more remaining portions to one or more additional accounts. In the example illustrated in FIG. 4A, a virtual wallet 250 may be initially generated by banking system 105 to transfer 402 funds (e.g., $50,000) kept at Bank A to the banking system 110 of another bank, Bank B. In connection with the generation of the virtual wallet 250, the originating system 105 may additional generate a corresponding wallet record 230 to identify the key used to encrypt content 310 within the virtual wallet 250 and identify the first destination (e.g., Bank B) to which the wallet is sent 402.

Upon receiving the virtual wallet 250 at Bank B, a user (e.g., using device 125) may request that a first portion of the funds (e.g., $10,000) be transferred to an account at Bank C (e.g., 320), while a second portion of the funds (e.g., $40,000) be transferred to an account at Bank D (e.g., 330), among other example scenarios. When the system 110 of Bank B receives the multiple transfer requests 404, the system 110 may identify that a transfer of less than the entire value of the virtual wallet is requested. In response, the system may determine that the wallet 250 is to be “split” or divided in order to facilitate the request and preserve protection afforded through the virtual wallet. Accordingly, the system 110 may identify that Bank A is the originator of the virtual wallet 250 (and funds represented by the wallet 250) and may communicate with the system 105 associated with Bank A to request 406 new wallets to accommodate the multiple transfers 404. The request 406 may identify that the funds within the original wallet 250 are to be split into two or more pieces and the request 406 may identify the amount of each of these pieces (e.g., a $10K portion and a $40K portion).

Turning to FIG. 4B, upon receiving the request 406 for a wallet split, the originating system 105 may convert the original wallet 250 into two new wallets 40, by generating the two new wallets 405, 410 (corresponding to division identified in the request 406), converting the single wallet record 230 into two wallet records 230a-b, and retiring the original wallet 250 and wallet record 230. The new wallet records 230a-b may identify that they correspond to a split of wallet 250. Further, new wallet records 230a-b may inherit the destination records of the parent wallet, such that the history of the transaction path of the parent wallet is retained, together with an identification of the downstream banking system (e.g., 110), which requested the split in the parent wallet. For instance, in other examples, a split may occur following the transfer of the wallet 250 to multiple downstream banking systems, and new wallet records created in response to the split can each include a destination record of each and every transferred-to banking system leading up to the split. Accordingly, as shown in the example of FIG. 4B, each of the new wallet records 230a-230b includes the destination record 315 identifying Bank B. Additionally, each of the two or more new wallets (e.g., 405, 410) may include respective encrypted content (e.g., 415, 420) each encrypted using a distinct key (e.g., 225a-b). Accordingly, the new wallet records 230a-b may identify the respective key (e.g., 225a-b) used to encrypt the content (e.g., 415, 420) of the corresponding virtual wallet 405, 410. In some implementations, the same key used to encrypt the original parent virtual wallet (e.g., 250) may be reused in one of the “child” virtual wallets (e.g., 405, 410) resulting from a split of the parent wallet. In other cases, entirely new keys (e.g., 225a-b) may be used to generate any child wallets (e.g., 405, 410) resulting from a split of a parent wallet, among other examples.

Upon generating the divided, child wallets 405, 410, the originating system 105 may send the child wallets to the requesting system 110. Upon receiving the child wallets 405, 410, the banking system 110 of Bank B may forward the received wallets 405, 410 to the respective banking systems (e.g., 320, 330) corresponding to the multiple transfer requests, which triggered the splitting of the original virtual wallet 250. For instance, in this example, the child wallet 405 corresponding to $10,000 is sent from Bank B 110 to Bank C 320, while the child wallet 410 corresponding to $40,000 is sent from Bank B 110 to Bank D 330. Continuing with this example, as shown in FIG. 4C, when the banking systems 320, 330 of the banks (e.g., Bank C and Bank D) receive the split, child wallets 405, 410, the banking systems 320, 330 may each identify that Bank A is the originator of the wallet and may send a respective reporting message (e.g., 422, 424) to identify that a respective one of the child wallets 405, 410 was forwarded to the banking system (e.g., 320, 330) from the banking system 110 of Bank B (analogous to the example illustrated and described in connection with FIGS. 3B-3C above). Further, upon receipt of the reporting messages 422, 424, the originating banking system 105 may update the corresponding wallet records 230a, 230b with destination records (e.g., 430, 435) corresponding to the respective recipient systems (e.g., 320, 330) of the child wallets (e.g., 405, 410).

After a wallet split event, each child wallet 405, 410 may be effectively handled and treated as a separate independent virtual wallet. For instance, as shown in the example of FIG. 4D, the wallets may be further transferred to additional downstream banking systems (e.g., 440, 445) and corresponding destination records (e.g., 450, 455) may added accordingly to the wallets' wallet records 230a-b. Additionally, a liquidation request (e.g., 460) may be received by the originating system 105 from one of the downstream banking systems (e.g., 440) corresponding to a particular one of the child wallets (e.g., 405). As in the example of FIG. 3D, receiving a liquidation request (e.g., 460) may cause the originating system 105 to identify the decryption key corresponding to the wallet (e.g., 405) to be liquidated, which the originating system 105 may provide to the current holder (e.g., 440) of the wallet 405 through a key sharing response (e.g., 465). Upon receipt of the decryption key from the originating system 105 corresponding to a virtual wallet 405, the liquidating system (e.g., 440) may decrypt content of the virtual wallet 405 to verify that the funds (e.g., $10,000) within the wallet 405 are to be liquidated, which may cause the wallet 405 and corresponding wallet record (e.g., 230a) to be retired at the originating system. Despite the child wallets 405, 410 sharing a common genesis (i.e., from the splitting of their respective parent wallet 250), liquidation of one of the child wallets (e.g., 405) does not affect the other child wallet(s). In particularly, liquidation of any one of the child wallets (e.g., 405, 410) is independent of the others and corresponds to the specific liquidation request (e.g., 460) and key share (e.g., 465) offered for that specific child wallet.

It should be appreciated that the examples offered in connection with the preceding discussion are offered for illustrative purposes only. Indeed, the more generalized principles discussed and illustrated herein may equally apply to other alternative use cases and example transactions. For instance, multiple split events may take place at multiple different points in the transfer of what began as a single wallet to cause the generation of multiple child wallets. Some child wallets may not be transferred from the banking system, which requested the split, such as where one of the child wallets is transferred to another downstream system, while another child wallet is immediately subject to a liquidation request at the system, which requested the preceding wallet split, among other example situations. Indeed, virtual wallets may be applied in a variety of different transactions of varying complexities, involving various combinations of systems, and assets.

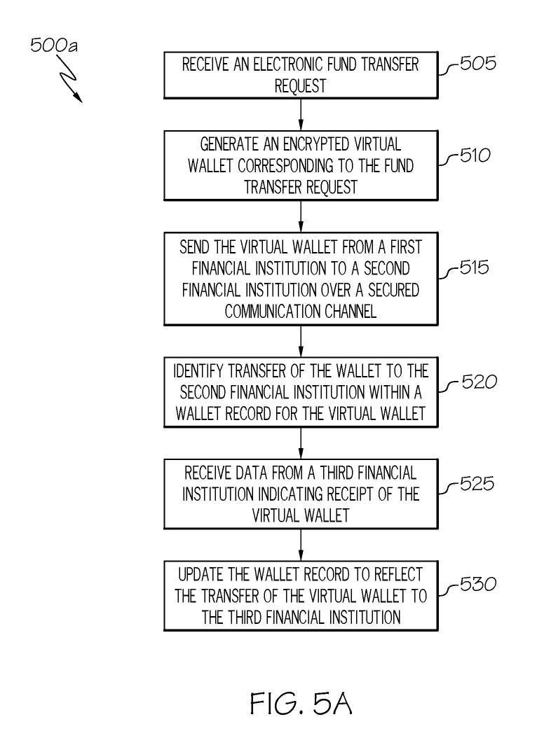

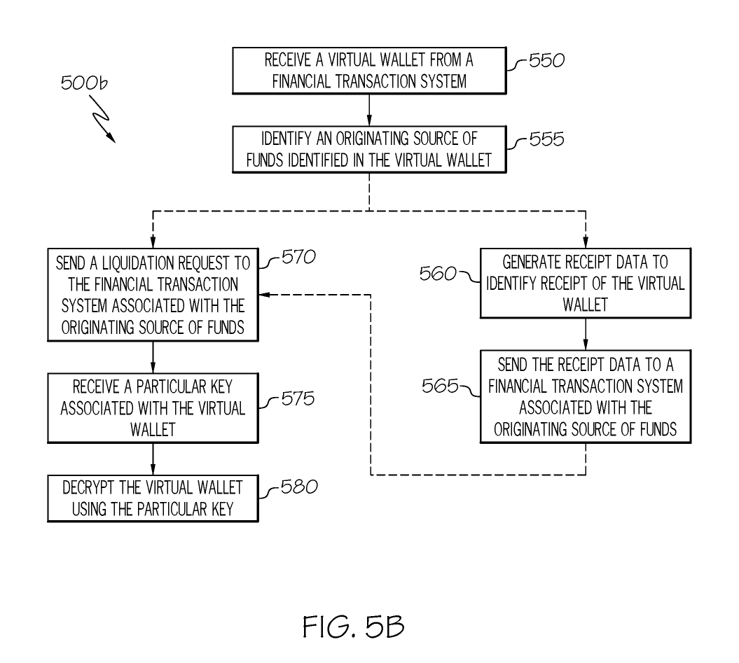

FIGS. 5A-5B are flowcharts 500a-b showing example techniques for performing transactions using example encrypted virtual wallets. For instance, in FIG. 5A, an electronic fund transfer request may be received 505 (or other request to transfer financial assets) at a particular computing system, such as a system associated with a bank, brokerage, securities firm, or other entity. An encrypted virtual wallet may be generated 510 to correspond to the assets to be transferred using a particular cryptographic key. A corresponding wallet record may be generated for the generated virtual wallet. The virtual wallet may then be sent 515 over a secure communication channel implemented over one or more networks connections from the originating system to a second recipient system that has been designated in the fund transfer request as the intended recipient of the assets. Transfer of the virtual wallet to the second system may be recorded and identified 520 within the wallet record for the virtual wallet. Subsequently, additional data may be received 525 by the originating system from a third system embodying a report by a third entity associated with the third system to identify that the virtual wallet has been transferred to the third system (e.g., by the second system). The wallet record for the virtual wallet may then be updated 530 at the originating system to reflect that the virtual wallet has been transferred to the third system associated with the third entity (e.g., an additional financial institution).

Turning to the example of FIG. 5B, a recipient system may receive 550 an encrypted virtual wallet, which corresponds to an amount of funds or other transferable asset. From the virtual wallet, the recipient system may identify 555 the originating system (e.g., the system which originally generated the virtual wallet and where the corresponding funds encapsulated in the virtual wallet originate). The recipient system may determine whether the virtual wallet was received directly from this originating system or a different system. In some cases, if the virtual wallet is not received directly from the originating system, the recipient system may generate 560 receipt data to report receipt of the virtual wallet and send 565 the receipt data (also referred to herein as reporting data or a reporting message herein) to the originating system. In some cases, the recipient system may always generate (e.g., 560) and second (e.g., 565) receipt data any time it receives a virtual wallet from another system. In some cases, the recipient system may attempt to gain approval from the originating system to liquidate the assets represented by the virtual wallet. For instance, the recipient system may identify the originating system and use this identification to send 570 a liquidation request to the originating system. If the liquidation is approved, the recipient system may expect and receive 575 a key share message from the originating system communicating a decryption key corresponding to the virtual wallet. The decryption key may then be used to decrypt 580 encrypted content of the virtual wallet to confirm that the recipient system (or corresponding institution) are authorized by the originator of the asset to liquidate the asset.

It should be appreciated that the flowcharts and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as suited to the particular use contemplated.

1. A method comprising:
receiving data comprising an electronic financial transfer request, wherein the electronic financial transfer request identifies that a first destination financial institution is a destination for a corresponding electronic financial transfer;
generating an encrypted virtual wallet, wherein the virtual wallet is encrypted by a particular key private to a first computing system associated with a second financial institution;
sending the encrypted virtual wallet to a second computing system associated with the first financial institution;
generating data comprising a transaction record associated with the virtual wallet, wherein the transaction record identifies the first destination financial institution, and the transaction record is private to the first computing system;
receiving data from a third computing system associated with a third financial institution to identify that the virtual wallet was transferred from the first financial institution to the third financial institution; and
updating the transaction record to identify that the virtual wallet was transferred from the first financial institution to the third financial institution.

2. The method of claim 1, further comprising:
receiving a liquidation request from the third computing system, wherein the liquidation request comprises a request to liquidate funds identified in the virtual wallet; and
sending the particular key to the third computing system over an encrypted communication channel based on the liquidation request, wherein the funds are liquidated to the third financial institution based on decryption of the virtual wallet by the third computing system.

3. The method of claim 2, wherein the particular key is secret to the second financial institution and the third financial institution.

4. The method of claim 2, wherein the virtual wallet comprises encrypted content and the encrypted content, when decrypted, comprises information for use in liquidating the funds identified in the wallet.

5. The method of claim 1, wherein the first computing system and the second computing system communicate over a secured network based on authentication by each of the first computing system and the second computing system to the secured network.

6. The method of claim 5, wherein the secured network comprises a Society for Worldwide Interbank Financial Telecommunication (SWIFT) network.

7. The method of claim 6, wherein the virtual wallet is sent from the first computing system to the second computing system over the SWIFT network.

8. The method of claim 6, wherein the virtual wallet is sent from the first computing system to the second computing system over an encrypted channel of a public network and corresponds to messaging between the first financial institution and the second financial institution over the SWIFT network relating to the electronic financial transfer.

9. The method of claim 1, wherein updating the transaction record causes the transaction record to describe flow of the electronic financial transfer from the second financial institution to the first financial institution and from the first financial institution to the third financial institution.

10. The method of claim 1, wherein the electronic financial transfer is transferred from the first financial institution to the third financial institution before liquidation of the electronic financial transfer at the first financial institution.

11. The method of claim 1, wherein the virtual wallet identifies that the second financial institution is a source of funds corresponding the electronic financial transfer and further identifies an amount of the funds.

12. The method of claim 1, further comprising:
receiving, from the third computing system, a transaction split request, wherein the transaction split requests identifies a request to transfer a first portion of the electronic financial transfer to one financial institution, and a second portion of the electronic financial transfer to another financial institution;
converting the virtual wallet into a first virtual wallet corresponding to the first portion of the electronic financial transfer and a second virtual wallet corresponding to the second portion of the electronic financial transfer, wherein the first virtual wallet is encrypted by a first key and the second virtual wallet is encrypted by a different, second key; and
generating a first transaction record to correspond to the first virtual wallet and a second transaction record to the correspond to the second virtual wallet.

13. The method of claim 12, wherein contents of the transaction record describing the transfer to the first financial institution and to the third financial institution are associated with each of the first and second transaction records.

14. The method of claim 12, further comprising:
receiving a first liquidation request to liquidate funds in the first portion of the electronic financial transfer;
sending the first key to a system requesting the first liquidation request based on the first liquidation request, wherein the funds in the first portion of the electronic financial transfer are liquidated based on decryption of the first virtual wallet using the first key;
receiving a second liquidation request to liquidate funds in the second portion of the electronic financial transfer; and
sending the second key to a system requesting the second liquidation request based on the second liquidation request, wherein the funds in the second portion of the electronic financial transfer are liquidated based on decryption of the second virtual wallet using the second key.

15. A computer program product comprising a computer readable storage medium comprising computer readable program code embodied therewith, the computer readable program code comprising:
computer readable program code configured to identify a request to complete an electronic fund transfer from a first financial institution to a second financial institution;
computer readable program code configured to generate a virtual wallet corresponding to the request, wherein the virtual wallet identifies the first financial institution as a source of funds of the electronic fund transfer, and the virtual wallet comprises an encrypted portion, encrypted using a particular encryption key private to a first computing system associated with the first financial institution;
computer readable program code configured to send, using a secured network channel, the virtual wallet from the first computing system to a second computing system associated with the second financial institution;
computer readable program code configured to generate a wallet record corresponding to the virtual wallet, wherein the wallet record is private to the first computing system and identifies transfer of the virtual wallet from the first financial institution to the second financial institution;
computer readable program code configured to receive data from a third computing system associated with a third financial institution, wherein the data identifies that the third computing system has received the virtual wallet; and
computer readable program code configured to update the wallet record to identify, based on the data, that the virtual wallet was transferred from the second financial institution to the third financial institution.

16. A system comprising:
a data processing apparatus;
a memory;
a first electronic fund transfer system associated with a first financial institution, executable by the data processing apparatus to:
receive an electronic financial transfer request from a second electronic fund transfer system associated with a second financial institution, wherein the electronic financial transfer request identifies a request to electronically transfer an amount of funds from the first financial institution to the second financial institution;
generate an encrypted virtual wallet corresponding to the transfer of the amount of funds, wherein the virtual wallet is encrypted by a particular key private to the first financial institution, and liquidation of the amount of funds identified in the virtual wallet requires decryption of the virtual wallet;
send the virtual wallet to the second electronic fund transfer system;
generate an electronic transaction record associated with the virtual wallet, wherein the transaction record identifies that the virtual wallet is sent to the second financial institution;
receive data from a third electronic fund transfer system associated with a third financial institution to identify that the virtual wallet was transferred to the third financial institution; and
update the transaction record to identify that the virtual wallet was transferred from the second financial institution to the third financial institution.

17. The system of claim 16, wherein the first electronic fund transfer system is further executable to:
receive a liquidation request from the third electronic fund transfer system, wherein the liquidation request comprises a request to liquidate the funds identified in the virtual wallet; and
send the particular key to the third computing system over an encrypted communication channel based on the liquidation request, wherein the funds are liquidated to the third financial institution based on decryption of the virtual wallet using the particular key.

18. The system of claim 16, wherein the first electronic fund transfer system is further executable to:
receive a transaction split request, wherein the transaction split requests identifies a request to transfer a first portion of the electronic financial transfer to one financial institution, and a second portion of the electronic financial transfer to another financial institution;
convert the virtual wallet into a first virtual wallet corresponding to the first portion of the electronic financial transfer and a second virtual wallet corresponding to the second portion of the electronic financial transfer, wherein the first virtual wallet is encrypted by a first key and the second virtual wallet is encrypted by a different, second key; and
generate a first transaction record to correspond to the first virtual wallet and a second transaction record to the correspond to the second virtual wallet.

19. The system of claim 16, wherein each of the first, second, and third comprises a respective linkage client to communicate over a secured financial transaction network.

20. The system of claim 16, further comprising the third electronic fund transfer system, executable to:
receive the virtual wallet from the second electronic fund transfer system;
identify the first financial institution from the virtual wallet;
generate receipt data corresponding to the virtual wallet; and
send the receipt data to the first electronic fund transfer system.
